(19) United States
(12) Patent Application Publication
(10) Pub. No.: US 2016/0224822 A1
(43) Pub. Date: Aug. 4, 2016

(54) COVER MEMBER, PERSONAL DIGITAL ASSISTANT AND DISPLAY DEVICE INCLUDING THE SAME, AND METHOD OF MANUFACTURING COVER GLASS

(71) Applicant: ASAHI GLASS COMPANY, LIMITED, Chiyoda-ku (JP)

(72) Inventors: Tomoharu HASEGAWA, Tokyo (JP); Makoto Sano, Tokyo (JP)

(73) Assignee: ASAHI GLASS COMPANY, LIMITED, Chiyoda-ku (JP)

(21) Appl. No.: 15/009,342

(22) Filed: Jan. 28, 2016

(30) Foreign Application Priority Data
Jan. 30, 2015 (JP) 2015-017254

(51) Int. Cl. G06K 9/00; C03C 21/00

(52) U.S. Cl. CPC G06K 9/00053; C03C 21/002; G06K 9/0002

(57) ABSTRACT

A cover member that protects at least one protection object includes a thin portion and a thick portion. The thin portion is formed by providing a concave portion on a back surface of the cover member. The thick portion is connected to the thin portion. A front surface of the thick portion is planar and a front surface of the thin portion is curved.

### CROSS-REFERENCE TO RELATED APPLICATIONS

This application claims priority from Japanese Patent Application No. 2015-017254 filed on Jan. 30, 2015, the entire subject matter of which is incorporated herein by reference.

### BACKGROUND OF THE INVENTION

1. Technical Field

The present invention relates to a cover member, a personal digital assistant and display device, which include the cover member, and a method of manufacturing a cover glass.

2. Background Art

Recently, as an advanced security measure for electronic apparatuses, a method of using a fingerprint for personal authentication has been actively used. Examples of the fingerprint authentication method include an optical type, a heat-sensitive type, a pressure-sensitive type, a capacitance type and an ultrasonic type. From the viewpoint of sensitivity and power consumption, a capacitance type or ultrasonic type is considered to be excellent.

When a detection object approaches or contacts a portion of a capacitance sensor, the capacitance sensor detects a change in the local capacitance of the portion. In a general capacitance sensor, the distance between an electrode arranged in the sensor and a detection object is measured based on the capacitance value. In addition, the ultrasonic sensor three-dimensionally detects a detection object by using ultrasonic waves. In this system, since ultrasonic waves go through foreign matters such as liquid, detection can be performed even under such a situation, and thus, this system is expected as biometric sensors having improved security. A system with a fingerprint authentication function using these sensors is small and lightweight and has low power consumption. Therefore, this system is mounted on a personal digital assistant (PDA) such as a smartphone, a mobile phone, or a tablet personal computer. Usually, in order to protect a capacitance sensor, a protective cover is arranged above the sensor.

For example, in capacitance sensor packaging disclosed in Patent Document 1, a hole is provided through a cover glass such that a sensor can detect an object, and a sensor cover is arranged in the hole.

Patent Document 1: WO 2013/173773 A1

### SUMMARY OF THE INVENTION

However, in the configuration disclosed in Patent Document 1 in which a hole is provided through a cover glass and a sensor cover is arranged in the hole, a jig for fixing the sensor cover to the hole is necessary. Therefore, the number of components increases, and the assembly process is complicated. Further, in addition to the cover glass, a different material such as the sensor cover is necessary. Therefore it is difficult to realize material unity, and the design is poor.

The present invention has been made in consideration of the above-described circumstances, and an object thereof is to provide: a cover member having a good design into which various apparatuses such as a sensor can be easily incorporated; a personal digital assistant and display device, which include the cover member; and a method of manufacturing a cover glass.

The above object in the present invention can be achieved by the following constitution.

(1) A cover member that protects at least one protection object, the cover member comprising:

a thin portion that is formed by providing a concave portion on a back surface of the cover member; and

a thick portion that is connected to the thin portion,

wherein a front surface of the thick portion is planar and a front surface of the thin portion is curved.

(2) The cover member according to (1), wherein the front surface of the thin portion is curved to have convex on a front side as compared to the front surface of the thick portion.

(3) A cover member that protects at least one protection object, the cover member comprising:

a thin portion that is formed by providing a concave portion on a front surface of the cover member; and

a thick portion that is connected to the thin portion,

wherein a back surface of the thick portion is planar and a back surface of the thin portion is curved.

(4) The cover member according to (3), wherein the back surface of the thin portion is curved to have convex on a back side as compared to the back surface of the thick portion.

(5) The cover member according to any one of (1) to (4), wherein the cover member is a glass.

(6) The cover member according to (5), wherein the glass is a chemically strengthened glass.

(7) The cover member according to any one of (1) to (6), wherein the protection object is a personal digital assistant.

(8) A personal digital assistant, comprising the cover member according to (7).

(9) The cover material according to any one of (1) to (7), wherein the protection object is a display panel.

(10) A display device, comprising the cover material according to (9).

(11) A method of manufacturing a cover glass that protects at least one protection object,

the cover glass being manufactured by chemically strengthening a glass member,

the glass member including: a thin portion that is formed by providing a concave portion on a back surface of the glass member; and a thick portion that is connected to the thin portion, and

the method comprising:

chemically strengthening the glass member, thereby deforming a front surface of the thin portion to be curved.

(12) A method of manufacturing a cover glass that protects at least one protection object,

the cover glass being manufactured by chemically strengthening a glass member,

the glass member including: a thin portion that is formed by providing a concave portion on a front surface of the glass member; and a thick portion that is connected to the thin portion, and

the method comprising:

chemically strengthening the glass member, thereby deforming a back surface of the thin portion to be curved.

According to the present invention, a cover member which is excellent in design and can be easily incorporated into various apparatuses such as sensor, a personal digital assistant and display device, which include the cover member, and a method of manufacturing a cover glass are provided.

### BRIEF DESCRIPTION OF THE DRAWINGS

FIG. 1 is a cross-sectional view of a cover member according to the first embodiment.

FIG. 2 is a cross-sectional view taken along line II-II of FIG. 1.

FIG. 3 is a cross-sectional view of a glass member.

FIG. 4 is a cross-sectional view of the glass member on which a concave portion is formed.

FIG. 5 is a cross-sectional view of a cover member.

FIG. 6 is a cross-sectional view of a cover member according to a modification example.

FIG. 7 is a cross-sectional view of a cover member according to another modification example.

FIG. 8 is a cross-sectional view of a cover member according to still another modification example.

FIG. 9 is a cross-sectional view of a cover member according to still another modification example.

FIG. 10 is a cross-sectional view of a cover member and glass member according to Example 2-1.

FIG. 11 is a cross-sectional view of a cover member and glass member according to Example 2-2.

FIG. 12 is a cross-sectional view of a cover member and glass member according to Example 2-3.

FIG. 13 is a cross-sectional view of a cover member and glass member according to Example 2-4.

FIG. 14 is a cross-sectional view of a cover member and glass member according to Comparative Example.

FIG. 15 is a cross-sectional view of a cover member according to the second embodiment.

FIG. 16 is a cross-sectional view taken along line XVI-XVI of FIG. 15.

### DETAILED DESCRIPTION OF THE INVENTION

Hereinafter, an embodiment of the present invention will be described. However, the present invention is not limited to the following embodiment. In addition, within a range not departing from the scope of the present invention, various modifications and substitutions can be made for the following embodiment.

### First Embodiment

The cover material according to the first embodiment of the present invention is a cover material that protects a protection object and includes: a thin portion that is formed by providing a concave portion on a back surface of the cover member; and a thick portion that is connected to the thin portion. A front surface of the thick portion is planar and a front surface of the thin portion is curved. This cover material is explained in detail below.

### (Cover Member)

A cover member according to the embodiment is used for protecting an arbitrary protection object. In the following explanation, a personal digital assistant such as a smartphone is taken as an example of the protection object of the cover member. However, an arbitrary object can be used as the protection object. For example, an electronic apparatus, e.g. a display device including a display panel, such as a touch panel sensor and a liquid crystal display device, can be used.

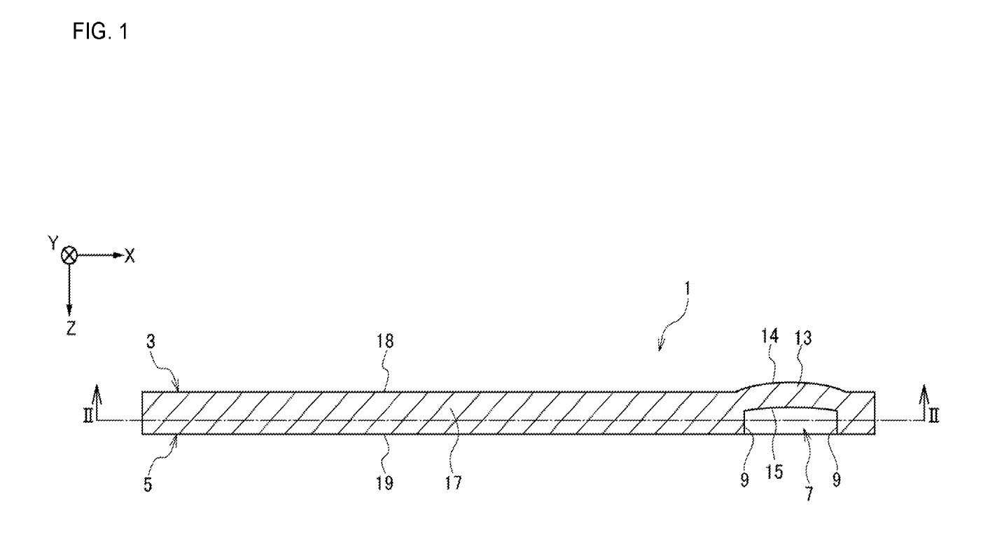

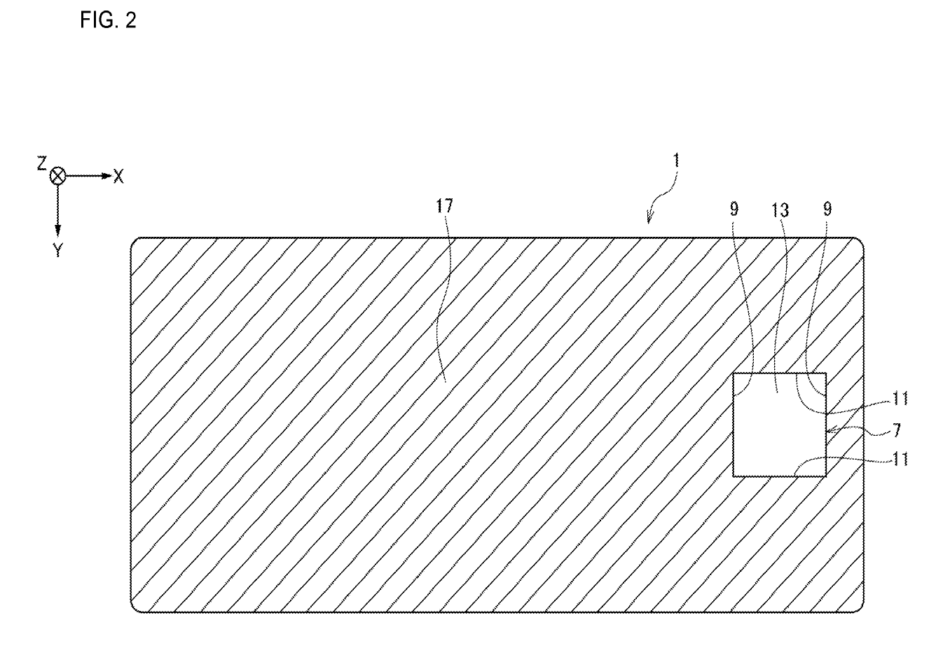

As shown in FIGS. 1 and 2, the cover member 1 according to the embodiment has an approximately planar rectangular parallelepiped shape as a whole. The cover member 1 has: a front surface 3 that is an upside surface in FIG. 1; and a back surface 5 that is a downside surface in FIG. 1 opposite to the front surface 3. In this specification, the front surface refers to an outside surface of an assembly including the cover member 1, that is, a surface which is touched by a user in a normal use state. In addition, the back surface refers to an inside surface of an assembly, that is, a surface which is not touched by a user in a normal use state. In addition, in the following explanation, a longitudinal direction of the cover member 1 will be referred to as “X direction”, a transverse direction thereof will be referred to as “Y direction”, and a thickness direction thereof will be referred to as “Z direction”.

On the back surface 5 of the cover member 1, at least one concave portion 7 is formed. The concave portion 7 according to the embodiment is formed near an end portion of the cover member 1 in the X direction and near the center of the cover member 1 in the Y direction. End surfaces 9 and 9 of the concave portion 7 in the X direction and end surfaces 11 and 11 of the concave portion 7 in the Y direction extend parallel to the Z direction. A position at which the concave portion 7 is formed may be set to an arbitrary position as long as it is positioned on the back surface 5 of the cover member 1.

By forming the concave portion 7 as described above, a thin portion 13 and a thick portion 17 are formed on the cover member 1, the thin portion 13 being formed at a position which overlaps the concave portion 7 in the X direction and the Y direction, and the thick portion 17 being connected to a peripheral portion of the thin portion 13 and having a greater thickness in the Z direction than the thin portion 13. A front surface 18 and a back surface 19 of the thick portion 17 are planar, whereas a front surface 14 and a back surface 15 of the thin portion 13 are curved. That is, the thin portion 13 is formed in an arch shape so as to be convex on the front side. In particular, the front surface 14 is curved so as to be convex on the front side as compared to the front surface 18 of the thick portion 17. Accordingly, due to geometric stiffness, the thin portion 13 has improved strength against a pressing force in a direction from the front side to the back side. In the embodiment, the back surface 15 of the thin portion 13 is curved as in the case of the front surface 14, but the present invention is not limited to this configuration. For example, the back surface 15 may be planar.

According to the cover member 1 having the above-described configuration, when it is incorporated into a case or the like to protect an arbitrary surface (for example, a front surface or a side surface) of a personal digital assistant, various apparatuses such as a sensor, a light apparatus or a camera can be arranged in the concave portion 7 formed on the back surface 5. Therefore, the space efficiency can be improved. Examples of the sensor include a fingerprint authentication sensor, a temperature sensor and the like. Here, an apparatus which is incorporated into the concave portion 7 is protected by the thin portion 13 opposite to the Z direction. Therefore, unlike the technique disclosed in Patent Document 1, the cover member 1 having material unity and a good design can be realized without using a different material such as a sensor cover. In addition, the number of components can be reduced, and the assembly process can be simplified. Therefore, there is a significant effect in cost reduction. Further, the front surface 18 of the thick portion 17 is planar, whereas the front surface 14 of the thin portion 13 is curved. Therefore, a user of a personal digital assistant can easily recognize the position of the thin portion 13 and the positions of various apparatuses on the back side of the thin portion 13, for example, by sight or touch.

Examples of a material constituting the cover member 1 include glass and a thermoplastic resin such as polyethylene terephthalate, polyvinyl chloride, polystyrene, an acrylic resin and polycarbonate. From the viewpoint of mechanical strength, weather resistance and transparency, glass is preferable. Further, when the cover member 1 is a glass, it is preferable that the glass is a chemically strengthened glass. The chemically strengthened glass has a compressive stress layer that is formed in a surface layer thereof by a chemical strengthening treatment. Therefore, high mechanical strength can be obtained.

In addition, as described above, the cover member 1 according to the embodiment is not limited to the case of being used for protecting a personal digital assistant. However, in particular, when the cover member 1 is used for protecting a personal digital assistant, the thickness of the thick portion 17 in the Z direction is 2.0 mm or less, preferably 1.5 mm or less, and more preferably 0.8 mm or less. The reason for this is as follows. When the thickness of the thick portion 17 is more than 2.0 mm, a difference in the thickness between the thin portion 13 and the thick portion 17 would increase. As a result, there is a problem in processing, and the weight of the cover member 1 is heavy for use in a personal digital assistant. In order to improve the stiffness, the thickness of the thick portion 17 in the Z direction is 0.1 mm or more, preferably 0.15 mm or more, and more preferably 0.2 mm or more. When the thickness of the thick portion 17 is less than 0.1 mm, the stiffness is excessively low, and the cover member 1 may not be used for protecting a personal digital assistant.

The cover material 1 according to the present embodiment may be planar or may have a curvature shape having at least one curvature part. In the cover material 1 having the curvature shape, the concave portion may be provided on the curvature part or on the flat plate part. The method of manufacturing the cover member 1 having the curvature shape is not particularly limited, and general methods such as a method of forming it by applying heat or the like to the cover member 1 to soften the same can be used. The concave portion may be formed before forming into the curvature shape or after forming into the curvature shape, but it is efficient to form the concave portion before forming into the curvature shape since positioning thereof can be easily controlled.

In addition, the cover material 1 according the present embodiment may have a hole in a part thereof. Thanks to this feature, the cover material 1 can be fixed to a case with a fixing member such as screw or a member having other function(s) can be attached thereto.

In addition, the thickness of the thin portion 13 in the Z direction should be thinner than the thickness of the thick portion 17 in the Z direction, and is basically 0.4 mm or less, preferably 0.35 mm or less, more preferably 0.3 mm or less, still more preferably 0.25 mm or less, even still more preferably 0.2 mm or less, and most preferably 0.1 mm or less. In a case where a capacitance sensor is arranged in the concave portion 7, as the thickness of the thin portion 13 is reduced, the detected capacitance increases, which improves the sensitivity. For example, in the case of fingerprint authentication in which fine convex and concave portions of a fingerprint of a fingertip are detected, a difference between capacitances corresponding to the fine convex and concave portions of the fingerprint of the fingertip increases. Therefore, the detection can be performed with high sensitivity. On the other hand, the lower limit of the thickness of the thin portion 13 in the Z direction is not particularly limited. However, when the thickness of the thin portion 13 is excessively small, the strength decreases, and thus it tends to be difficult to appropriately function as a protective portion for a sensor or the like. Accordingly, the thickness of the thin portion 13 in the Z direction is, for example, 0.01 mm or more and more preferably 0.05 mm or more. The thickness of the thick portion 17 in the Z direction is preferably 10 times or less and more preferably 8 times or less than the thickness of the thin portion 13 in the Z direction. When the thickness of the thick portion 17 in the Z direction is 10 times or more than the thickness of the thin portion 13 in the Z direction, there may be a problem in processing. The lower limit of a ratio of the thickness of the thick portion 17 in the Z direction to the thickness of the thin portion 13 in the Z direction is not particularly limited and can be set according to an intended use. When the cover member 1 is used for protecting a display device or personal digital assistant, typically, the lower limit of the ratio is 1.5 times or more. An area ratio of the thin portion 13 to the thick portion 17 is ½ or lower, preferably ⅓ or lower, and more preferably ¼ or lower. When the area ratio of the thin portion 13 to the thick portion 17 is higher than ½, the strength may significantly decrease.

As described above, the front surface 14 of the thin portion 13 has a warped shape of protruding on the front side (Z direction) as compared to the front surface 18 of the thick portion 17. The amount of warpage of the thin portion 13 (the distance in the Z direction between a standard surface defined by the front surface 3 and a portion which protrudes most in the front surface 14) is not particularly limited and is appropriately set according to the size of a protection object of the cover member 1 or the intended use thereof. However, in order to easily recognize the position of the thin portion 13 and the positions of various apparatuses on the back side of the thin portion 13, the amount of warpage of the thin portion 13 is preferably 5 μm or more and more preferably 10 μm or more. In addition, from the viewpoint of design, the amount of warpage of the thin portion 13 is preferably 500 μm or less and more preferably 200 μm or less.

The Young's modulus of the thin portion 13 is 60 GPa or higher, preferably 65 GPa or higher, and more preferably 70 GPa or higher. When the Young's modulus of the thin portion 13 is 60 GPa or higher, damage to the thin portion 13 caused by collision with a foreign collision object can be sufficiently prevented. In addition, when a fingerprint authentication sensor such as a capacitance sensor is arranged in the concave portion 7, damage to the thin portion 13 caused by dropping or collision of a smartphone or the like can be sufficiently prevented. Further, for example, damage to a sensor to be protected by the thin portion 13 can be sufficiently prevented. In addition, the upper limit of the Young's modulus of the thin portion 13 is not particularly limited. From the viewpoint of productivity, the Young's modulus of the thin portion 13 is, for example, 200 GPa or lower and preferably 150 GPa or lower.

The Vickers hardness Hv of the thin portion 13 is preferably 400 or higher and more preferably 500 or higher. When the Vickers hardness of the thin portion 13 is 400 or higher, scratches on the thin portion 13 caused by collision with a foreign collision object can be sufficiently prevented. In addition, when a fingerprint authentication sensor such as a capacitance sensor is arranged in the concave portion 7, scratches on the thin portion 13 caused by dropping or collision of a smartphone or the like can be sufficiently prevented. Further, for example, damage to a sensor to be protected by the thin portion 13 can be sufficiently prevented. In addition, the upper limit of the Vickers hardness of the thin portion 13 is not particularly limited. However, when the Vickers hardness is excessively high, there may be a problem in polishing or processing. Accordingly, the Vickers hardness of the chemically strengthened glass is, for example, 1,200 or lower and preferably 1,000 or lower. The Vickers hardness can be measured in a Vickers hardness test described in, for example, JIS Z 2244.

The relative dielectric constant of the thin portion 13 at a frequency of 1 MHz is preferably 7 or higher, more preferably 7.2 or higher, and still more preferably 7.5 or higher. When the capacitance sensor is arranged in the concave portion 7, by increasing the relative dielectric constant of the thin portion 13, the detected capacitance can be increased, and superior sensitivity can be realized. In particular, by adjusting the relative dielectric constant of the thin portion 13 at a frequency of 1 MHz to be 7 or higher, in the case of fingerprint authentication in which fine convex and concave portions of a fingerprint of a fingertip are detected, a difference between capacitances corresponding to the fine convex and concave portions of the fingerprint of the fingertip increases. Therefore, the detection can be performed with high sensitivity. In addition, the upper limit of the relative dielectric constant of the thin portion 13 is not particularly limited. However, when the relative dielectric constant is excessively high, dielectric loss may increase, power consumption may increase, and a reaction may become slow. The relative dielectric constant of the thin portion 13 at a frequency of 1 MHz is preferably 20 or lower and more preferably 15 or lower. The relative dielectric constant can be determined by measuring the capacitance of a capacitor in which electrodes are formed on both surfaces of the cover member 1.

The arithmetic average roughness (Ra) of the front surface 14 of the thin portion 13 is not particularly limited and is preferably 300 nm or less and more preferably 30 nm or less. In a case where the fingerprint authentication sensor such as a capacitance sensor is arranged in the concave portion 7, from the viewpoint of increasing the sensitivity, it is preferable that the arithmetic average roughness Ra of the front surface 14 of the thin portion 13 is 300 nm or less because it is sufficiently small as compared with the degree of convex and concave of a fingerprint of a finger. In addition, the lower limit of the arithmetic average roughness Ra of the front surface 14 of the thin portion 13 is not particularly limited and is preferably 0.3 nm or more and more preferably 1.0 nm or more. From the viewpoint of improving the strength, it is preferable that the arithmetic average roughness Ra of the front surface 14 of the thin portion 13 is 0.3 nm or more. The arithmetic average roughness Ra of the front surface 14 of the thin portion 13 can be adjusted by the selection of, for example, a polishing stone or a polishing method. In addition, the arithmetic average roughness Ra of a first surface of the chemically strengthened glass can be measured based on JIS B 0601 (1994). On the other hand, the arithmetic average roughness Ra of the back surface 15 of the thin portion 13 is also not particularly limited and may be the same as or different from that of the front surface 14.

### (Method of Manufacturing Cover Glass)

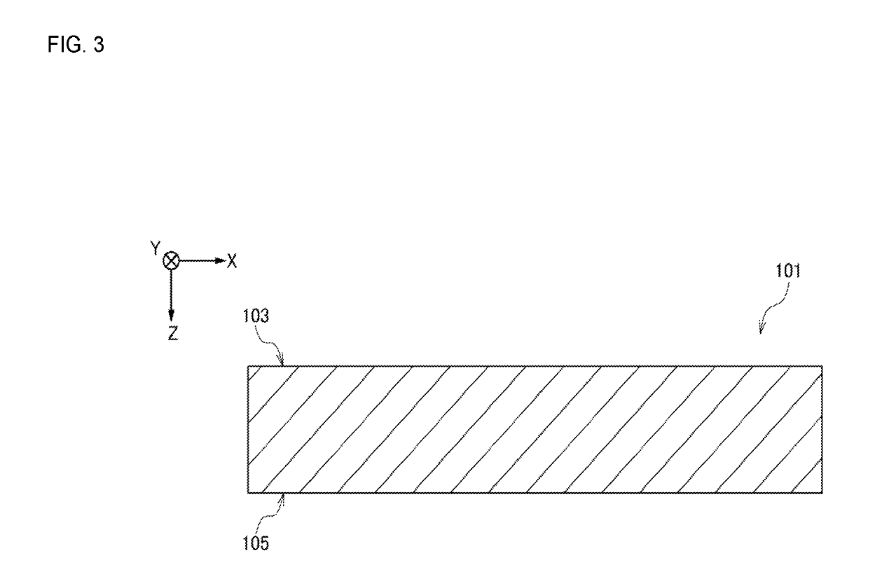

Next, when the cover member 1 according to the embodiment is a cover glass formed of a chemically strengthened glass, a method of manufacturing the cover glass will be described. First, raw materials of the respective components are prepared so as to have a composition described below, followed by heating and melting in a glass furnace. Glass is homogenized by, for example, bubbling, stirring, or addition of a clarifying agent, and the homogenized glass is formed into a glass plate having a predetermined thickness using a well-known forming method, and then, the glass plate is annealed. Examples of the glass forming method include a float method, a press method, a fusion method, a down-draw method, and a roll-out method. In particular, a float method suitable for mass production is preferable. In addition, continuous forming methods other than the float method, that is, the fusion method and the down-draw method are also preferable. The glass member which is formed into a plate shape using an arbitrary forming method is annealed, followed by cutting into a desired size (the size of the cover member 1), and subjecting to polishing processing. As a result, a glass member 101 shown in FIG. 3, which has a planar front surface 103 and a planar back surface 105 and has a plate shape as a whole, is obtained.

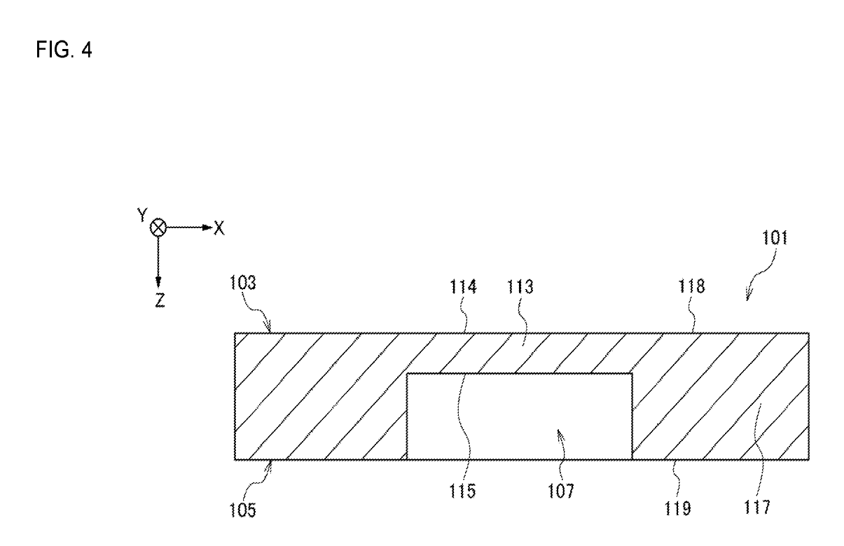

Next, as shown in FIG. 4, a concave portion 107 is formed by etching the back surface 105 of the glass member 101. Although not shown in the figures, due to the etching, corner portions of the concave portion 107 are curved (to have R-shape). Therefore, the strength can be improved. The concave portion 107 may be formed by press-forming the glass member 101 formed into a plate shape in a state of being melted by reheating or by casting molten glass on a press die, followed by press-forming. When the thickness of a thin portion 113 is not sufficiently small even after press forming, the thickness can be adjusted by additionally etching the concave portion 107 or by polishing the front surface 114 side.

By providing the concave portion 107, a thin portion 113 and a thick portion 117 are formed on the glass member 101, the thin portion 113 being formed at a position which overlaps the concave portion 107 in the X direction and the Y direction, and the thick portion 117 being connected to a peripheral portion of the thin portion 113 and having a greater thickness in the Z direction than the thin portion 113. Here, a front surface 118 and back surface 119 of the thick portion 117 and a front surface 114 and back surface 115 of the thin portion 113 are planar, and the front surface 118 of the thick portion 117 and the front surface 114 of the thin portion 113 are connected to each other on the same plane.

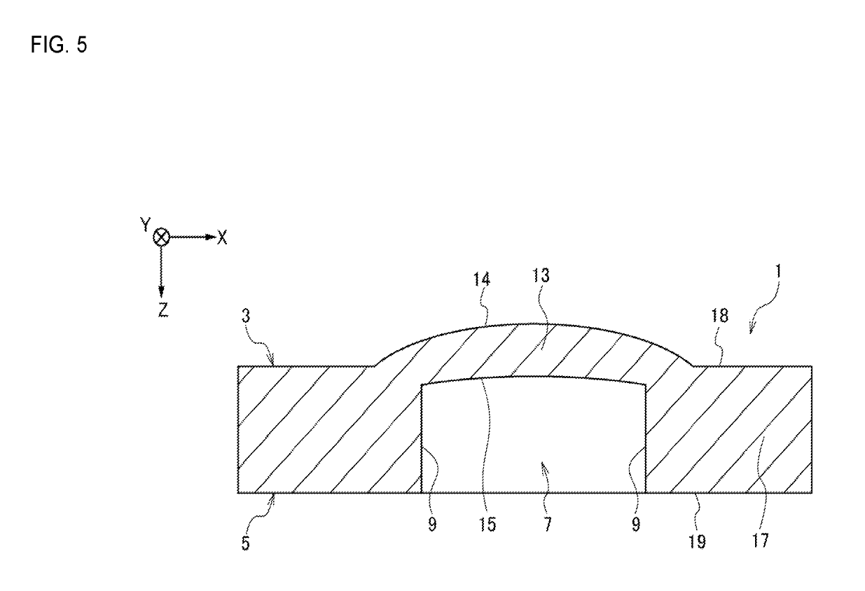

Next, by subjecting the glass member 101 to a chemical strengthening treatment, the cover member 1 shown in FIG. 5 is obtained. The chemical strengthening treatment refers to a treatment of substituting (ion exchanging) alkali ions (for example, sodium ions) having a small ionic radius in the surface layer of the glass with alkali ions (for example, potassium ions) having a large ionic radius. The method of the chemical strengthening treatment is not particularly limited as long as alkali ions in the surface layer of the glass can be exchanged with alkali ions having a larger ionic radius. For example, the chemical strengthening treatment can be performed by treating glass containing sodium ions with molten salt containing potassium ions. Due to the above-described ion exchange treatment, the composition of the center part of a substrate in the thickness direction is substantially the same as the composition thereof before the ion exchange treatment although the composition of a compressive stress layer in a glass surface layer is slightly different from the composition thereof before the ion exchange treatment.

When glass containing sodium ions is used as the glass to be chemically strengthened, it is preferable that molten salt containing at least potassium ions is used as the molten salt for the chemical strengthening treatment. Preferable examples of the molten salt include potassium nitrate. It is preferable that the molten salt has high purity.

In addition, the molten salt may be a mixed molten salt containing the other component(s). Examples of the other component(s) include: an alkali sulfate such as sodium sulfate or potassium sulfate; an alkali chloride such as sodium chloride or potassium chloride; a carbonate such as sodium carbonate or potassium carbonate; and a bicarbonate such as sodium bicarbonate or potassium bicarbonate.

The heating temperature of the molten salt is preferably 350° C. or higher, more preferably 380° C. or higher, and still more preferably 400° C. or higher. In addition, the heating temperature of the molten salt is preferably 500° C. or lower, more preferably 480° C. or lower, and still more preferably 450° C. or lower. By adjusting the heating temperature of the molten salt to be 350° C. or higher, a problem that chemical strengthening is less likely performed, caused by a decrease in ion exchange rate, is prevented. In addition, by adjusting the heating temperature of the molten salt to be 500° C. or lower, the decomposition and deterioration of the molten salt can be suppressed.

In order to impart sufficient compressive stress, the contact time between the glass and the molten salt is preferably 1 hour or longer and more preferably 2 hours or longer. In addition, when the ion exchange treatment is performed for a long period of time, the productivity decreases, and the compressive stress value decreases due to relaxation. Therefore, the contact time is preferably 24 hours or shorter and more preferably 20 hours or shorter. Specifically, for example, typically, the glass is dipped in molten potassium nitrate at 400° C. to 450° C. for 2 hours to 24 hours. The number of times of carrying out the chemical strengthening is not particularly limited, and should be at least one, or may be two under different conditions.

In the cover member 1 (cover glass) obtained by chemically strengthening the glass member 101, a compressive stress layer is formed in the surface thereof. The surface compressive stress (CS) of the compressive stress layer is preferably 300 MPa or higher and more preferably 400 MPa or higher.

CS can be measured using a surface stress meter (for example, FSM-6000, manufactured by Orihara Manufacturing Co., Ltd.).

When sodium ions in a glass surface layer are exchanged with potassium ions in molten salt by chemical strengthening, the depth of the surface compressive stress layer (depth of layer; DOL) formed by chemical strengthening can be measured using an arbitrary method. For example, using an electron probe micro-analyzer (EPMA), the alkali ion concentration (in this example, potassium ion concentration) in the thickness direction of glass is analyzed, and the ion diffusion depth obtained by the measurement can be set as DOL. In addition, DOL can be measured using a surface stress meter (for example, FSM-6000, manufactured by Orihara Manufacturing Co., Ltd.). In addition, when lithium ions in a glass surface layer are exchanged with sodium ions in molten salt, the sodium ion concentration in the thickness direction of glass is analyzed using an EPMA, and the ion diffusion depth obtained by the measurement is set as DOL.

The internal tensile stress (Central Tension; CT) of the cover member 1 (cover glass) is preferably 200 MPa or lower, more preferably 150 MPa or lower, still more preferably 100 MPa or lower, and most preferably 80 MPa or lower. In general, CT can be approximately obtained from a relational expression “CT=(CS×DOL)/(t−2×DOL)” wherein t represents the thickness of the cover member 1. Accordingly, in the glass member 101 according to the embodiment, the thickness of the thin portion 113 in the Z direction is less than the thickness of the thick portion 117 in the thickness direction. Therefore, when the thin portion 113 and the thick portion 117 are chemically strengthened under the same conditions, CT of the thin portion 13 is higher than CT of the thick portion 17 in the cover member 1 after chemical strengthening.

In a case where the thin portion 113 and thick portion 117 of the glass member 101 are chemically strengthened under the same conditions as described above, the thin portion 13 and thick portion 17 of the cover member 1 have different CT values. As a result, during chemical strengthening, the thin portion 13 expands as compared with the thick portion 17. The thin portion 13 expands in a state where a periphery thereof is restricted by the thick portion 17, and thus, a surface thereof on the front side is deformed (refer to FIG. 5). In this case, the front surface 18 of the thick portion 17 is planar, whereas the front surface 14 of the thin portion 13 is curved. Therefore, a user of a smartphone or the like can easily recognize the position of the thin portion 13 and the positions of various apparatuses on the back side of the thin portion 13, for example, by sight or touch.

The amount of warpage of the thin portion 13 after chemical strengthening can be adjusted, for example, by using the following method.

By performing a predetermined heat treatment on the cover member 1 after chemical strengthening, the amount of warpage of the thin portion 13 can be reduced. That is, after performing the ion exchange treatment on the glass member 101, a heat treatment is performed on the cover member 1 at 50° C. or higher and lower than a strain point thereof. As a result, the amount of warpage of the thin portion 13 can be reduced.

The amount of warpage of the thin portion 13 after chemical strengthening can also be adjusted by processing the thin portion 113 of the glass member 101 in advance before chemical strengthening into a shape which is estimated in consideration of the amount of warpage after chemical strengthening. For example, when it is desired to reduce the amount of warpage of the surface of the thin portion 13 on the front side after chemical strengthening, the thin portion 113 before chemical strengthening may be processed in advance into a shape of being curved to the back side. In addition, when it is desired to increase the amount of warpage of the surface of the thin portion 13 on the front side after chemical strengthening, the thin portion 113 before chemical strengthening may be processed in advance into a shape of being curved to the front side.

After chemical strengthening, the warpage of the glass plate is occurred due to different degree of entry of chemical strengthening on the front surface and the back surface of the glass plate. For example, by performing a fluorine treatment on the front surface and/or back surface of the glass plate, a difference between the fluorine concentration on the front surface and the fluorine concentration on the back surface is adjusted to be equal to or higher than a specific range. As a result, the ion diffusion rate on the front surface and back surface of the glass plate is adjusted, and the degree of entry of chemical strengthening on the front surface and the back surface can be adjusted. In this way, by adjusting the degree of entry of chemical strengthening on the front surface and the back surface, the warpage of the glass plate after chemical strengthening can be adjusted. Accordingly, in a step of supplying molten glass onto molten metal to form a glass ribbon, a step of blowing gas containing molecules in which a fluorine atom is present in the structure thereof toward a front surface and back surface of the glass ribbon at different supply rates is provided. As a result, the amount of warpage of the thin portion 13 after chemical strengthening can be adjusted. In addition, in a step of supplying molten glass onto molten metal to form a glass ribbon, a step of blowing gas containing molecules in which a fluorine atom is present in the structure thereof toward either a front surface or back surface of the glass ribbon may also be provided. Even in this case, the amount of warpage of the thin portion 13 after chemical strengthening can be adjusted.

The strain point of the glass member 101 before chemical strengthening is preferably 530° C. or higher. By adjusting the strain point of the glass member 101 before chemical strengthening to be 530° C. or higher, the relaxation of the surface compressive stress is not likely to occur.

The cover member 1 may be a glass which has not been chemically strengthened. The cover member 1 (refer to FIG. 5), which includes the concave portion 7 and the thin portion 13 having the front surface 14 having a curved shape, is manufactured by press-forming the glass member 101 (refer to FIG. 3) formed into a plate shape in a state of being melted by reheating it or by casting molten glass on a press die, followed by press-forming. When the cover member 1 is formed by press forming as described above, a die for forming the front surface 14 of the thin portion 13, which has convex shape on the front side is used. Further, according to need (for example, when an apparatus arranged in the concave portion 7 is a capacitance fingerprint authentication sensor), in order to adjust the thin portion 13 to have an appropriately small thickness, the concave portion 7 may be additionally etched, or the front surface 14 or back surface 15 of the thin portion 13 may be polished.

It is preferable that a printing layer is provided on the back surface 5 of the cover member 1, in particular, on the back surface 15 of the thin portion 13. By providing the printing layer, a personal digital assistant, which is a protection object of the cover member 1, various sensors arranged in the concave portion 7, and the like can be efficiently prevented from being recognized by sight through the cover member 1. In addition, a desired color can be imparted thereto, a good appearance can be obtained. From the viewpoint of maintaining high capacitance of the cover member 1 (thin portion 13), the thickness of the printing layer is preferably 20 μm or less, more preferably 15 μm or less, and still more preferably 10 μm or less.

The printing layer can be formed of an ink composition containing a predetermined color material. In addition to the color material, the ink composition may contain a binder, a dispersant, a solvent and the like according to need. The color material may be a color material (colorant) such as a pigment or a dye. Among these, one kind or a combination of two or more kinds can be used. The color material can be appropriately selected according to a desired color. For example, when light shielding properties are required, for example, a black color material is preferably used. In addition, the binder is not particularly limited, and examples thereof include well-known resins (for example, a thermoplastic resin, a thermosetting resin, or a photo curable resin) such as a polyurethane resin, a phenol resin, an epoxy resin, an urea melamine resin, a silicone resin, a phenoxy resin, a methacrylic resin, an acrylic resin, a polyacrylate resin, a polyester resin, a polyolefin resin, a polystyrene resin, polyvinyl chloride, a vinyl chloride-vinyl acetate copolymer, polyvinyl acetate, polyvinylidene chloride, polycarbonate, cellulose, or polyacetal. Among these, one kind or a combination of two or more kinds can be used as the binder.

A printing method for forming the printing layer is not particularly limited, and an appropriate printing method such as a gravure printing method, a flexographic printing method, an offset printing method, a relief printing method, a screen printing method or a pad printing method can be used.

As shown in FIGS. 1, 2, and 5, the wall surfaces of the concave portion 7 such as the end surfaces 9 and 9 in the X direction and the end surfaces 11 and 11 in the Y direction are parallel to the Z direction, the printing layer may not be sufficiently formed. In this case, by a light source irradiating the cover member 1 with light from the back surface 5 side, light penetrates the end surfaces 9 and 9 in the X direction and the end surfaces 11 and 11 in the Y direction where the printing layer is not formed. As a result, the position of the concave portion 7 and the positions of various apparatuses arranged in the concave portion 7 can be easily recognized by sight.

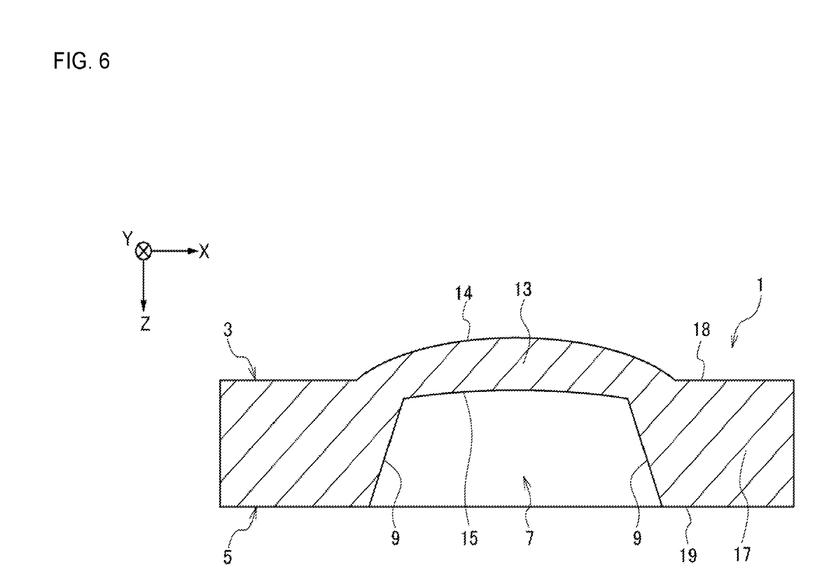

By tapering the wall surfaces of the concave portion 7 such as the end surfaces 9 and 9 in the X direction and the end surfaces 11 and 11 in the Y direction as shown in FIG. 6, the formation of the printing layer on the wall surfaces may be promoted. In this case, an effect of increasing the stiffness of the concave portion 7 can be expected.

### (Glass Composition)

As the glass (glass member 101) provided for chemical strengthening, for example, any one of the following glasses (i) to (vii) may be used. The following glass compositions (i) to (v) are represented by mol % in terms of oxides, and the following glass compositions (vi) to (vii) are represented by wt % in terms of oxides.

(i) A glass including 50% to 80% of SiO₂, 2% to 25% of Al₂O₃, 0% to 10% of Li₂O, 0% to 18% of Na₂O, 0% to 10% of K₂O, 0% to 15% of MgO, 0% to 5% of CaO, and 0% to 5% of ZrO₂.

(ii) A glass including 50% to 74% of SiO₂, 1% to 10% of Al₂O₃, 6% to 14% of Na₂O, 3% to 11% of K₂O, 2% to 15% of MgO, 0% to 6% of CaO, and 0% to 5% of ZrO₂, in which a total content of SiO₂ and Al₂O₃ is 75% or lower, a total content of Na2O and K₂O is 12% to 25%, and a total content of MgO and CaO is 7% to 15%.

(iii) A glass including 68% to 80% of SiO₂, 4% to 10% of Al₂O₃, 5% to 15% of Na₂O, 0% to 1% of K₂O, 4% to 15% of MgO, and 0% to 1% of ZrO₂, in which a total content of SiO₂ and Al₂O₃ is 80% or lower.

(iv) A glass including 67% to 75% of SiO₂, 0% to 4% of Al₂O₃, 7% to 15% of Na₂O, 1% to 9% of K₂O, 6% to 14% of MgO, 0% to 1% of CaO, and 0% to 1.5% of ZrO₂, in which a total content of SiO₂ and Al₂O₃ is 71% to 75%, and a total content of Na₂O and K₂O is 12% to 20%.

(v) A glass including 60% to 75% of SiO₂, 0.5% to 8% of Al₂O₃, 10% to 18% of Na₂O, 0% to 5% of K₂O, 6% to 15% of MgO, and 0% to 8% of CaO.

(vi) A glass including 63% to 75% of SiO₂, 3% to 12% of Al₂O₃, 3% to 10% of MgO, 0.5% to 10% of CaO, 0% to 3% of SrO, 0% to 3% of BaO, 10% to 18% of Na₂O, 0% to 8% of K₂O, 0% to 3% of ZrO₂, and 0.005% to 0.25% of Fe₂O₃, in which R₂O/Al₂O₃ (wherein R₂O represents Na₂O+K₂O) is 2.0 or more and 4.6 or less.

(vii) A glass including 66% to 75% of SiO₂, 0% to 3% of Al₂O₃, 1% to 9% of MgO, 1% to 12% of CaO, 10% to 16% of Na₂O, and 0% to 5% of K₂O.

### (Thermoplastic Resin)

When the cover member 1 is formed of a thermoplastic resin, the cover member 1 according to the embodiment is formed by injection forming or extrusion forming using a die for forming the front surface 14 of the thin portion 13 to have convex shape on the front side.

### MODIFICATION EXAMPLE

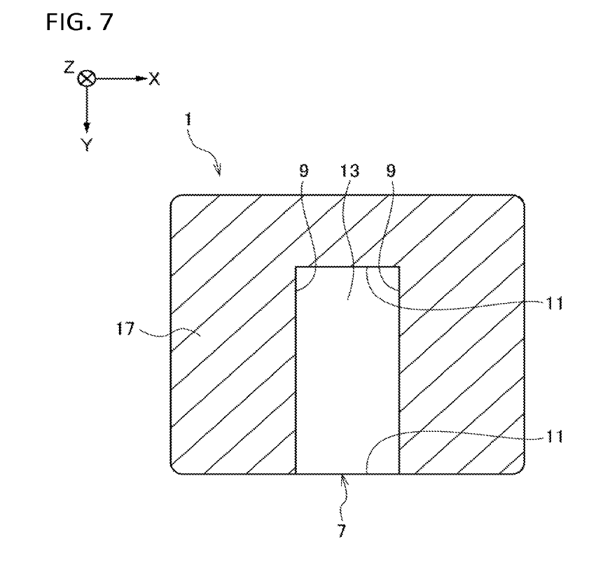

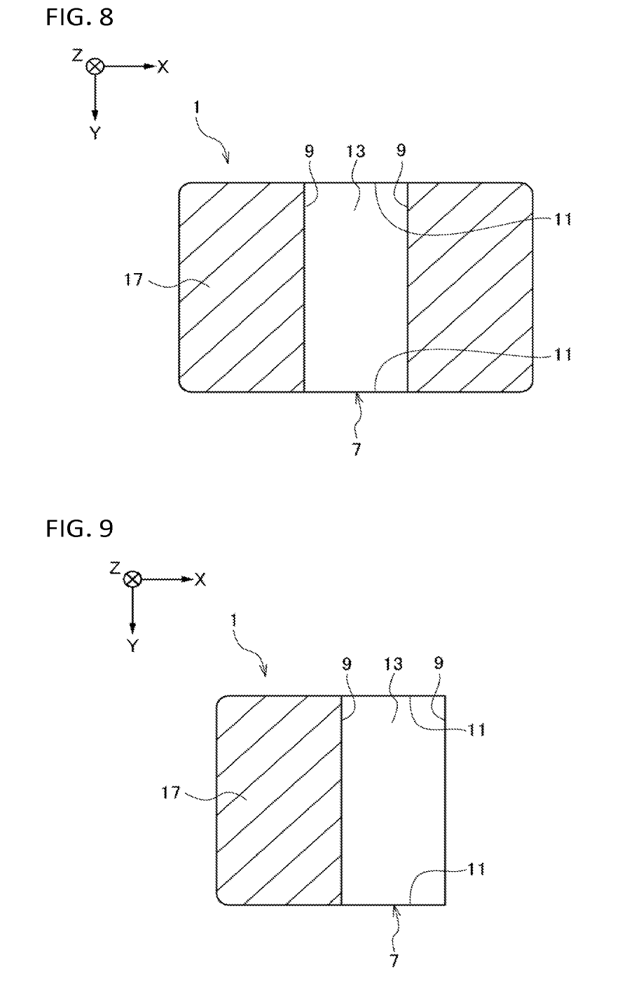

Hereinabove, the cover member 1 in which the periphery (four end portions) of the thin portion 13 on a XY plane is connected to the thick portion 17 has been described. As shown in FIG. 7, a configuration in which three end portions of the thin portion 13 are connected to the thick portion 17 may be adopted. In this case, one end portion of the thin portion 13 (in an example of FIG. 7, an end portion in the Y direction) is an open end without being connected to the thick portion 17. In addition, as shown in FIG. 8, a configuration in which two end portions of the thin portion 13 are connected to the thick portion 17 may be adopted. In this case, two end portions of the thin portion 13 (in an example of FIG. 8, end portions in the Y direction) are open ends without being connected to the thick portion 17. In addition, as shown in FIG. 9, a configuration in which one end portion of the thin portion 13 is connected to the thick portion 17 may be adopted. In this case, three end portions of the thin portion 13 (in an example of FIG. 9, end portions in the Y direction and an end portion in the X direction) are open ends without being connected to the thick portion 17. In this way, at least a part of the periphery of the thin portion 13 is open without being connected to the thick portion 17. As a result, in Examples described below, the amount of warpage of the thin portion 13 after chemical strengthening can be reduced. In this way, the amount of warpage of the thin portion 13 can be adjusted.

In addition, the number of concave portions 7 provided on the back surface 5 may be plural. In this case, the number of thin portions 13 may also be the same as the number of concave portions 7. For example, when plural sensors are arranged on the back surface of the cover member 1, the number of the sensors may be the same as the number of concave portions 7.

In addition, the shape of the concave portion 7 is not particularly limited and may be an arbitrary shape. For example, when it is seen from the Z direction, a cross-sectional shape of the concave portion 7 is not limited to a rectangular shape and may be, for example, a circular shape or a triangular shape.

### Second Embodiment

The cover material according to the second embodiment of the present invention is a cover material that protects a protection object and includes: a thin portion that is formed by providing a concave portion on a front surface of the cover member; and a thick portion that is connected to the thin portion. A back surface of the thick portion is planar and a back surface of the thin portion is curved. This cover material is explained in detail below.

The second embodiment is the same as the first embodiment except that the surface on which the concave portion is formed is different. In the second embodiment, the preferable embodiments for the constitution requirements same as those in the first embodiments are the same as the preferable embodiments in the first embodiment.

### (Cover Member)

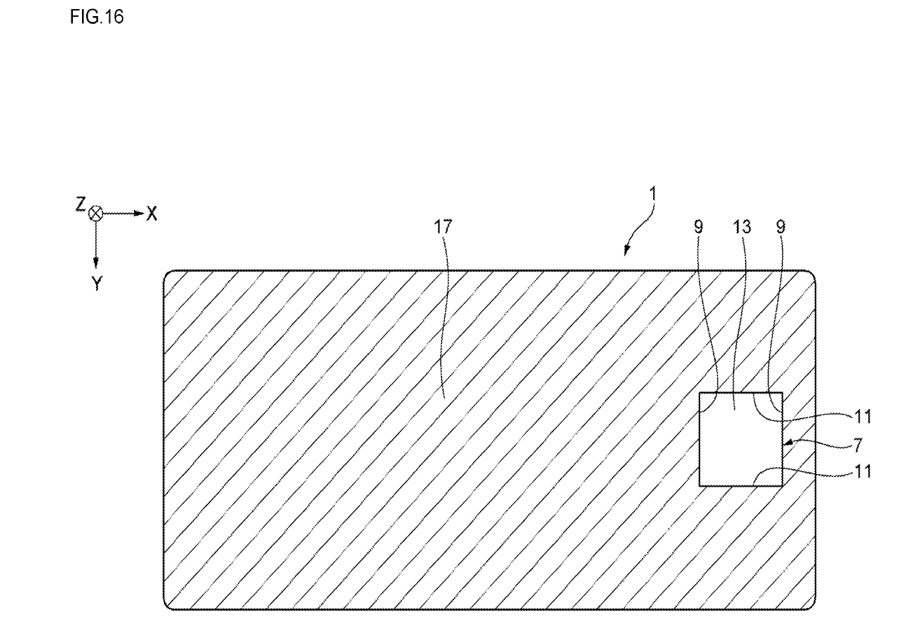

As shown in FIGS. 15 and 16, the cover member 1 according to the embodiment has an approximately planar rectangular parallelepiped shape as a whole. The cover member 1 has: a front surface 3 that is a downside surface in FIG. 15; and a back surface 5 that is an upside surface in FIG. 15 opposite to the front surface 3. On the front surface 3 of the cover member 1, at least one concave portion 7 is formed. The concave portion 7 according to the embodiment is formed near an end portion of the cover member 1 in the X direction and near the center of the cover member 1 in the Y direction. End surfaces 9 and 9 of the concave portion 7 in the X direction and end surfaces 11 and 11 of the concave portion 7 in the Y direction extend parallel to the Z direction. A position at which the concave portion 7 is formed may be set to an arbitrary position as long as it is positioned on the front surface 3 of the cover member 1.

By forming the concave portion 7 as described above, a thin portion 13 and a thick portion 17 are formed on the cover member 1, the thin portion 13 being formed at a position which overlaps the concave portion 7 in the X direction and the Y direction, and the thick portion 17 being connected to a peripheral portion of the thin portion 13 and having a greater thickness in the Z direction than the thin portion 13. A front surface 18 and a back surface 19 of the thick portion 17 are planar, whereas a front surface 14 and a back surface 15 of the thin portion 13 are curved. That is, the thin portion 13 is formed in an arch shape so as to be convex on the back side. In particular, the back surface 15 is curved so as to be convex on the back side as compared to the back surface 19 of the thick portion 17. Accordingly, due to geometric stiffness, the thin portion 13 has improved strength against a pressing force in a direction from the back side to the front side. In the embodiment, the front surface 14 of the thin portion 13 is curved as in the case of the back surface 15, but the present invention is not limited to this configuration. For example, the front surface 14 may be planar.

According to the cover member 1 having the above-described configuration, in a case where it is incorporated into a case or the like to protect an arbitrary surface (for example, a front surface or a side surface) of a personal digital assistant and various apparatuses such as a sensor is arranged on the back surface 15, when a human contacts the cover member 1, the position can be easily recognized by the concave portion 7 formed on the front surface 3 through, for example, sight or touch. In particular, when the cover member according to the embodiment is used for in-car display devices, a driver can recognize the position of the concave portion 7 only by touch without depending on sight and handle it, and thus, the cover member contributes to safe driving. An apparatus in which various apparatuses are arranged on the back surface 15 is protected by the thin portion 13 opposite to the Z direction. Therefore, unike the technique disclosed in Patent Document 1, the cover member 1 having material unity and a good design can be realized without using a different material such as a sensor cover. In addition, the number of components can be reduced, and the assembly process can be simplified. Therefore, there is a significant effect in cost reduction. Further, even if a personal digital assistant is dropped or the surface of the cover material is contacted with something, there is an advantage that the thin portion is hardly broken since the concave is formed on the surface of the thin portion.

The number of concave portions 7 provided on the front surface 3 may be plural. In this case, the number of thin portions 13 may also be the same as the number of concave portions 7. For example, when plural sensors are arranged on the back surface of the cover member 1, the number of the sensors may be the same as the number of concave portions 7.

### EXAMPLES

Hereinafter, the present invention will be described using Examples, but the present invention is not limited thereto.

### Example 1

When the cover members 1 formed of a chemically strengthened glass were obtained by chemically strengthening the glass members 101, chemical strengthening conditions and the thickness of the thin portion 113 in the Z direction were changed. In this case, an effect on the amount of warpage of the thin portion 13 after chemical strengthening was verified based on Examples 1-1 to 1-6.

First, a method of obtaining the cover members 1 of Examples 1-1 to 1-6 will be described. Regarding each of Examples 1-1 to 1-6, a glass for chemical strengthening “DRAGONTRAIL” (registered trade name; manufactured by Asahi Glass Co., Ltd.) was cut such that the width in the X direction was 35 mm, the width in the Y direction was 35 mm, and the thickness in the Z direction was 0.7 mm. The cut glass was grinded and polished, thereby obtaining the glass member 101 (for example, refer to FIG. 3).

Next, the center part of the back surface 105 of the glass member 101 was etched. As a result, the concave portion 107 in which the width in the X direction was 20 mm and the width in the Y direction was 18 mm was formed (for example, refer to FIG. 4). The thicknesses of the concave portions 107 in the Z direction in the respective Examples were different as follows: Example 1-1: 0.60 mm, Example 1-2: 0.55 mm, Example 1-3: 0.50 mm, Example 1-4: 0.60 mm, Example 1-5: 0.55 mm, and Example 1-6: 0.50 mm. Accordingly, the thicknesses of the thin portions 113 in the Z direction in the respective Examples were different as follows: Example 1-1: 0.1 mm, Example 1-2: 0.15 mm, Example 1-3: 0.2 mm, Example 1-4: 0.1 mm, Example 1-5: 0.15 mm, and Example 1-6: 0.2 mm. That is, the dimensions of the concave portions 107 and the thin portions 113 were set to be the same as each other in Examples 1-1 and 1-4, in Examples 1-2 and 1-5, and in Examples 1-3 and 1-6, respectively. Here, during etching, the masked glass member 101 was etched with hydrofluoric acid so as to obtain the desired concave portion 107.

Finally, the glass members 101 in the respective Examples were chemically strengthened to obtain cover members 1 (for example, refer to FIG. 5) in the respective Examples. The chemical strengthening conditions were adjusted as follows: in Examples 1-1 to 1-3, the glass members 101 were dipped in molten potassium nitrate at 410° C. for 4 hours; and in Examples 1-4 to 1-6, the glass members 101 were dipped in molten potassium nitrate at 410° C. for 2 hours.

Regarding each of the cover members 1 in the respective Examples, the amount of warpage of the thin portion 13 after chemical strengthening was measured, and the results thereof are shown in Table 1. Here, the amount of warpage of the thin portion 13 refers to the distance in the Z direction between a standard surface defined by the front surface 3 in FIG. 5 and a portion which protrudes most from the front surface 14. In addition, the amount of warpage of the thin portion 13 was measured by scanning a XY plane using a surface displacement sensor.

TABLE 1

| | Ex. | Ex. | Ex. | Ex. | Ex. | Ex. |
|---|---|---|---|---|---|---|
| | 1-1 | 1-2 | 1-3 | 1-4 | 1-5 | 1-6 |
| Thickness (mm) of thin | 0.1 | 0.15 | 0.2 | 0.1 | 0.15 | 0.2 |
| portion | | | | | | |
| Chemical strengthening | 4 | 4 | 4 | 2 | 2 | 2 |
| time (h) | | | | | | |
| (Thickness of thick portion)/ | 7 | 4.7 | 3.5 | 7 | 4.7 | 3.5 |
| (Thickness of thin portion) | | | | | | |
| Amount of warpage of thin | 0.656 | 0.453 | 0.303 | 0.484 | 0.332 | 0.189 |
| portion (mm) | | | | | | |

When Examples 1-1 to 1-3 and Examples 1-4 to 1-6 are compared to each other, it can be found that, as the thickness of the thin portion 113 in the Z direction before chemical strengthening increases, that is, as the value of (the thickness of the thick portion 117 in the Z direction/the thickness of the thin portion 113 in the Z direction) decreases, the amount of warpage of the thin portion 13 after chemical strengthening decreases. The reason for this is presumed to be as follows. As the thickness in the Z direction increases, the internal tensile stress CT of the thin portion 13 would decrease to be close to CT of the thick portion 17. Therefore, a difference in expansion between the thin portion 13 and the thick portion 17 would be reduced. Accordingly, it is presumed that the amount of warpage of the thin portion 13 after chemical strengthening would also be reduced by reducing the thickness of the thick portion 117 in the Z direction before chemical strengthening.

In addition, when Examples 1-1 and 1-4, Examples 1-2 and 1-5, and Examples 1-3 and 1-6 are compared to each other, it can be found that, as the chemical strengthening time decreases, the amount of warpage of the thin portion 13 after chemical strengthening is reduced. The reason for this is presumed to be as follows. As the chemical strengthening time decreases, strengthening conditions are alleviated, and a difference in CT between the thin portion 13 and the thick portion 17 would be reduced. Therefore, a difference in expansion between the thin portion 13 and the thick portion 17 would be reduced. Accordingly, it is presumed that the amount of warpage of the thin portion 13 would also be reduced by lowering the treatment temperature during chemical strengthening, in addition to the chemical strengthening time.

In this way, it is obvious that the amount of warpage of the thin portion 13 after chemical strengthening can be adjusted by changing the thicknesses of the thin portion 113 and the thick portion 117 in the Z direction before chemical strengthening or by changing the chemical strengthening conditions.

### Example 2

When the cover members 1 formed of a chemically strengthened glass were obtained by chemically strengthening the glass members 101, a range where the periphery of the thin portion 13 was connected to the thick portion 17 was changed. In this case, an effect on the amount of warpage of the thin portion 13 after chemical strengthening was verified based on Examples 2-1 to 2-4 and Comparative Example.

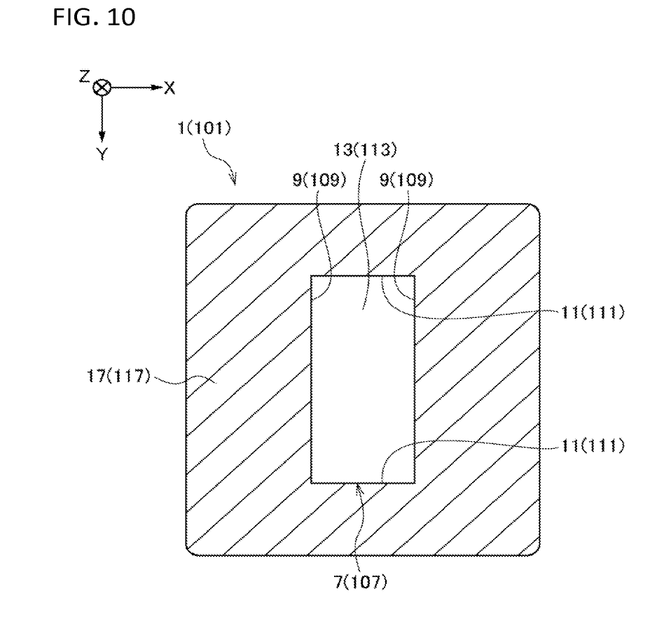

First, a method of obtaining the cover members 1 of Examples 2-1 to 2-4 and Comparative Example shown in FIGS. 10 to 14 will be described. Regarding each of Examples 2-1 to 2-4 and Comparative Example, a glass for chemical strengthening “DRAGONTRAIL” (registered trade name; manufactured by Asahi Glass Co., Ltd.) was cut, grinded, and polished, thereby obtaining the glass member 101 (for example, refer to FIG. 3). Table 2 shows the width in the X direction, the width in the Y direction, and the thickness in the Z direction regarding each of the glass members 101 in Examples 2-1 to 2-4 and Comparative Example.

TABLE 2

| | Exam- | Exam- | | | |
|---|---|---|---|---|---|
| | ple | ple | Example | Example | Comparative |
| | 2-1 | 2-2 | 2-3 | 2-4 | Example |
| Width (mm) | 35 | 35 | 35 | 22 | 9 |
| in X direction | | | | | |
| Width (mm) in | 35 | 27 | 18 | 19 | 19 |
| Y direction | | | | | |
| Thickness | 0.71 | 0.71 | 0.71 | 0.71 | 0.33 |
| (mm) in | | | | | |
| Z direction | | | | | |

Next, as shown in FIGS. 10 to 13, the back surface 105 of the glass member 101 in each of Examples 2-1 to 2-4 was etched. As a result, the concave portion 107 in which the width in the X direction was 10 mm, the width in the Y direction was 20 mm, and the thickness in the Z direction was 0.33 mm was formed. Here, the etching treatment was performed using the same method as in Example 1.

As shown in FIG. 10, in the glass member 101 of Example 2-1, the concave portion 107 was provided at the center part on a XY plane, and the periphery (four end portions) of the thin portion 113 was connected to the thick portion 117.

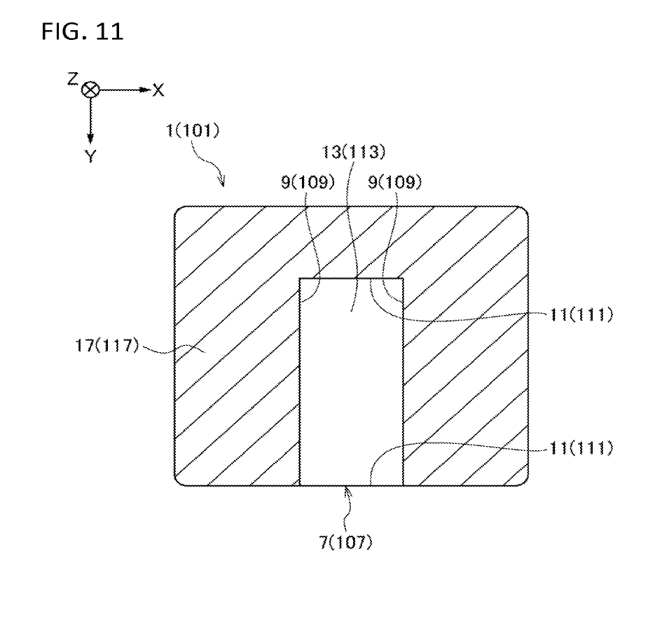

As shown in FIG. 11, the glass member 101 of Example 2-2 had a shape in which a portion of the thick portion 117, which was positioned on one end portion side (in FIG. 11, downside) in the Y direction as compared to the thin portion 113, was removed from the glass member 101 in Example 2-1. That is, three end portions of the thin portion 113 were connected to the thick portion 117, and one end portion of the thin portion 113 (an end portion in the Y direction) was an open end without being connected to the thick portion 117.

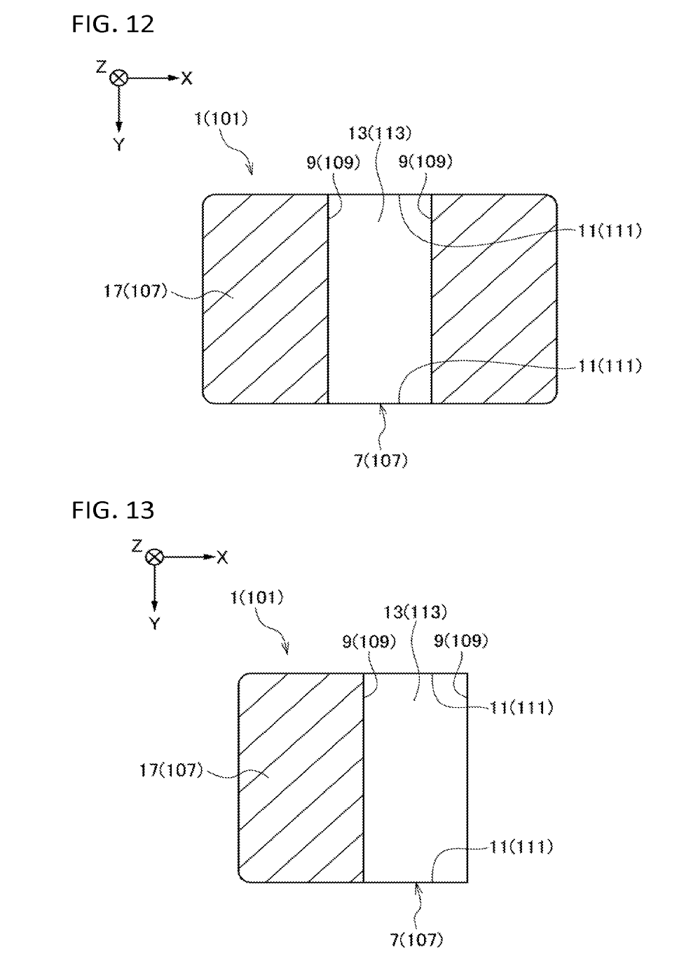

As shown in FIG. 12, the glass member 101 of Example 2-3 had a shape in which a portion of the thick portion 117, which was positioned on the other end portion side (in FIG. 12, upside) in the Y direction as compared to the thin portion 113, was removed from the glass member 101 in Example 2-2. That is, two end portions of the thin portion 113 were connected to the thick portion 117, and two end portion of the thin portion 113 (both end portions in the Y direction) were open ends without being connected to the thick portion 117.

As shown in FIG. 13, the glass member 101 of Example 2-4 had a shape in which a portion of the thick portion 117, which was positioned on one end portion side (in FIG. 13, right side) in the X direction as compared to the thin portion 113, was removed from the glass member 101 in Example 2-3. That is, one end portion of the thin portion 113 was connected to the thick portion 117, and three end portions of the thin portion 113 (both end portions in the Y direction and one end portion in the X direction) were open ends without being connected to the thick portion 117.

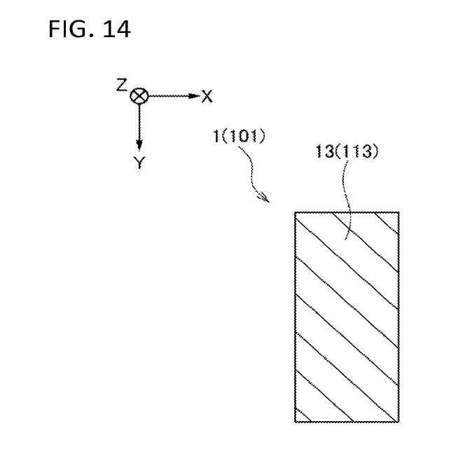

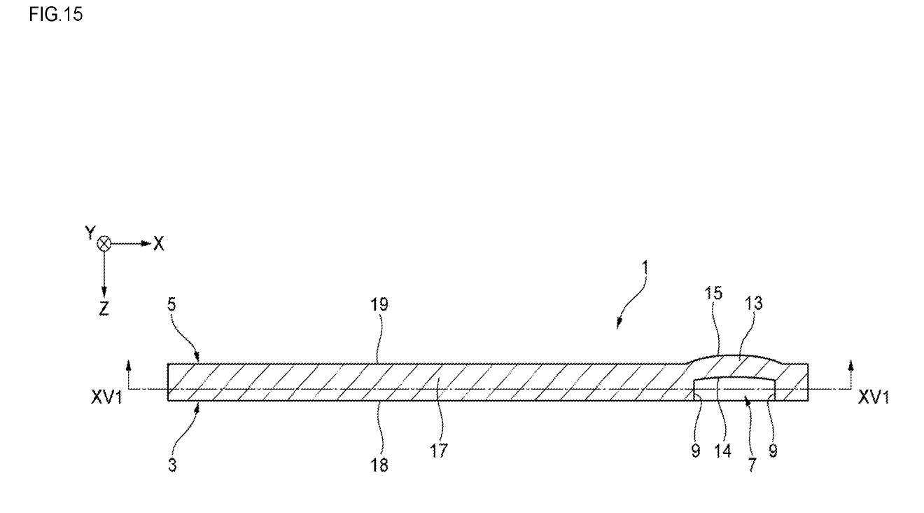

As shown in FIG. 14, the glass member 101 of Comparative Example had a shape in which a portion of the thick portion 117, which was positioned on the other end portion side (in FIG. 14, left side) in the X direction as compared to the thin portion 113, was removed from the glass member 101 in Example 2-4. That is, the glass member 101 in Comparative Example was formed of only the thin portion 113 without including the thick portion 117, and the periphery (four end portions) of the thin portion 113 was open ends.

Finally, the glass members 101 in the respective Examples and Comparative Example were chemically strengthened, thereby obtaining cover members 1 (refer to FIGS. 10 to 14) in the respective Examples and Comparative Example. The chemical strengthening conditions were adjusted as follows: the glass members 101 were dipped in 100% molten potassium nitrate at 425° C. for 4 hours.

Regarding each of the cover members 1 in the respective Examples and Comparative Example, the amount of warpage of the thin portion 13 after chemical strengthening was measured, and the results thereof are shown in Table 3. The amount of warpage of the thin portion 13 was measured using a laser displacement meter.

TABLE 3

| | Example | Example | Example | Example | Comparative |
|---|---|---|---|---|---|
| | 2-1 | 2-2 | 2-3 | 2-4 | Example |
| Number of | 0 | 1 | 2 | 3 | 4 |
| open ends | | | | | |
| Amount of | 0.14 | 0.1 | 0.05 | 0.04 | 0.001 |
| warpage | | | | | |
| (mm) of | | | | | |
| thin | | | | | |
| portion | | | | | |

It can be found that, as the number of open ends increases, the amount of warpage of the thin portion 13 after chemical strengthening decreases. The reason for this is presumed to be as follows. Stress which was induced in the thin portion 13 due to a difference in expansion between the thin portion 13 and the thick portion 17 was released by the open ends.

In this way, it is obvious that, when at least a part of the periphery of the thin portion 13 is open without being connected to the thick portion 17, the amount of warpage of the thin portion 13 after chemical strengthening can be reduced. Accordingly, the amount of warpage of the thin portion 13 can be adjusted by changing the range where the periphery of the thin portion 13 is connected to the thick portion 17.

### DESCRIPTION OF REFERENCE NUMERALS AND SIGNS

1: Cover Member

3: Front Surface

5: Back Surface

7: Concave Portion

9: End Surface in X Direction

11: End Surface in Y Direction

13: Thin Portion

14: Front Surface

15: Back Surface

17: Thick Portion

18: Front Surface

19: Back Surface

101: Glass Member

105: Back Surface

107: Concave Portion

113: Thin Portion

114: Front Surface

115: Back Surface

117: Thick Portion

118: Front Surface

119: Back Surface

What is claimed is:

1. A cover member that protects at least one protection object, the cover member comprising:
a thin portion that is formed by providing a concave portion on a back surface of the cover member; and
a thick portion that is connected to the thin portion,
wherein a front surface of the thick portion is planar and a front surface of the thin portion is curved.

2. The cover member according to claim 1, wherein the front surface of the thin portion is curved to have convex on a front side as compared to the front surface of the thick portion.

3. A cover member that protects at least one protection object, the cover member comprising:
a thin portion that is formed by providing a concave portion on a front surface of the cover member; and
a thick portion that is connected to the thin portion,
wherein a back surface of the thick portion is planar and a back surface of the thin portion is curved.

4. The cover member according to claim 3, wherein the back surface of the thin portion is curved to have convex on a back side as compared to the back surface of the thick portion.

5. The cover member according to claim 1, wherein the cover member is a glass.

6. The cover member according to claim 3, wherein the cover member is a glass.

7. The cover member according to claim 5, wherein the glass is a chemically strengthened glass.

8. The cover member according to claim 6, wherein the glass is a chemically strengthened glass.

9. The cover member according to claim 1, wherein the protection object is a personal digital assistant.

10. The cover member according to claim 3, wherein the protection object is a personal digital assistant.

11. A personal digital assistant, comprising the cover member according to claim 9.

12. A personal digital assistant, comprising the cover member according to claim 10.

13. The cover material according to claim 1, wherein the protection object is a display panel.

14. A display device, comprising the cover material according to claim 13.

15. The cover material according to claim 3, wherein the protection object is a display panel.

16. A display device, comprising the cover material according to claim 15.

17. A method of manufacturing a cover glass that protects at least one protection object,
the cover glass being manufactured by chemically strengthening a glass member,
the glass member including: a thin portion that is formed by providing a concave portion on a back surface of the glass member; and a thick portion that is connected to the thin portion, and
the method comprising:
chemically strengthening the glass member, thereby deforming a front surface of the thin portion to be curved.

18. A method of manufacturing a cover glass that protects at least one protection object,
the cover glass being manufactured by chemically strengthening a glass member,
the glass member including: a thin portion that is formed by providing a concave portion on a front surface of the glass member; and a thick portion that is connected to the thin portion, and
the method comprising:
chemically strengthening the glass member, thereby deforming a back surface of the thin portion to be curved.
